(19) United States
(12) Patent Application Publication
(10) Pub. No.: US 2010/0106592 A1
(43) Pub. Date: Apr. 29, 2010

(54) One account visa/master card/gift card systems and methods

(76) Inventor: Danette Maire Brown, Gardena, CA (US)

Correspondence Address: Danette Brown, 14714 Budlong Ave, #5, Gardena, CA, 90247, US

(21) Appl. No.: 12/583,936

(22) Filed: Aug. 28, 2009

Related U.S. Application Data
(60) Provisional application No. 61/092,625, filed on Aug. 28, 2008.

(51) Int. Cl. G06Q 40/00; G06Q 30/00; G06K 19/00; G06Q 20/00

(52) U.S. Cl. 705/14.34; 705/14.67; 235/487; 705/41

(57) ABSTRACT

A method for providing an one account gift card for purchases of goods and/or services by establishing the account at a merchant based on a user's input, and enabling the account to be accessed by the beneficiary with the use of a financial card subject to the terms and conditions of the merchant: The consumer is then able to use the available funds in the account towards purchases of services and/or goods at the merchant.

One car, one account, all funds from multiple people=one account gift card.

### CROSS-REFERENCE TO RELATED PATENT APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM

### LISTING COMPACT DISK APPENDIX

Not Applicable.

### BACKGROUND

1. Field

The claimed subject matter relates to gift card systems and methods which allow beneficiaries to register to receive gifts from others and use those gifts by making purchases with financial payment cards such as credit and debit cards.

2. Description of the Related Art

Credit card product providers have been increasingly offering a variety of payment products to consumers of credit and to consumers that wish to use alternative forms of payment such as credit and debit cards. One example of a popular gift card system or program offered includes the sale of gift cards in supermarkets which can be used as gifts to make purchases in the same or other stores. Many types of gift card programs are operated by the stores themselves and the credit card companies. Gift cards increase loyalty to the stores as the consumer purchasing or receiving the card will tend to go to the outlet to purchase products or services from that store. In one example, airline travelers can purchase a gift card to make purchases of flights or miles which can be used for purchasing flights. These types of gift card programs have been successful because the cards offer convenient ways to receive as well as to use monetary gifts.

### SUMMARY

The claimed subject matter'relates to the one account gift card methods and use of the gift card process systems.

The one account gift card method is where a consumer establishes an account with a merchant and has one gift card for purchase of goods and/or services which multiple people can add funds to one gift card. This function is not available on any other gift card, which is why this a unique method and process.

According to one aspect, a method for providing an account for purchases of goods and/or services by a consumer may include designating a consumer to receive an amount associated with an account established for said consumer, establishing the account at a merchant based on the user's input, and enabling the account to be accessed by the consumer with the use of a financial card such as a gift card subject to the terms and conditions of the merchant, wherein the consumer can use the account towards purchase of services and/or goods at the merchant.

According to another aspect, a method for providing an account for purchases of goods and/or services by consumer may further include creating personalized content based on the user input, creating a personalized advertisement based on the user input, and delivering the personalized advertisement to the consumer based on the personalized content

In yet another aspect of the claimed subject matter, a computer network-based purchase incentive system may be used for one or more merchants which includes a memory, the memory adapted to store a program code capable of programming the processor to perform a method for providing an account from a merchant for a purchase of a good or service by a consumer. The system includes a method having the steps of designating a beneficiary to receive an amount associated with an account established for the beneficiary, establishing the account at a merchant based on user's input, and enabling the account to be accessed by the beneficiary with the use of a financial card subject to the terms and conditions of said merchant, wherein said beneficiary uses the account towards purchases of services and/or goods at the merchant.

Another aspect includes a computer program product for use in conjunction with a computer system, the computer program product including a computer readable storage medium and a computer program mechanism embedded within the product, the computer program mechanism having a program module with the program module including instructions for providing an account from a merchant for a purchase of a good service by a consumer including designating a beneficiary to receive an amount associated with an account established for the beneficiary, establishing the account at a merchant based on a user's input, and enabling said account to be accessed by the beneficiary with the use of a financial card subject to the terms and conditions of said merchant, wherein said beneficiary uses said account towards purchases of services and/or goods at said merchant.

FIG. 1 is an exemplary flow chart depicting an embodiment showing the establishment and redemption of an One Account VISA/Master Card/Gift Card account in accordance with the claimed subject matter. As Shown in FIG. 1, a consumer or user may establish a new account with a merchant using a customer interface such as an online website interface or a kiosk style interface, for example a kiosk location in any one of the merchant's physical locations.

The customer would enter the relevant data, such as name and social security number, in order to receive an account number. The account number will be associated with the invitee account at the point of interface which will issue an receipt for the customer. In the described embodiments, the interface may connect to a database and program which can track and update the information associates with the customer and/or account number or may store information so it can be communicated to a computer at a later time.

For example, in one implementation, a consumer of a large retail establishment such as Target or Wal-Mart could use a kiosk located in any department, such as the jewelry department in order to setup an One Account Visa/Mater Card/Gift Card account. The consumer would enter their information and an account number would be assigned. The consumer could make a payment at the kiosk using a credit or debit card depositing funds into the account. This same process can be done at the store's customer service department.

Customized advertising may also be presented to consumer at the kiosk or on the card so that it can be seen by the beneficiary. The card's usage information is stored in central computer along with any other customer related information obtained from the customer or designated beneficiary.

Once an account number is obtained and the account is activated, other individuals and businesses may deposit funds into the account. In one implementation, the customer invites others to make deposits and the invitees can visit the merchant either online, calling an 800 number or at a physical location such as kiosk and add funds to the account.

In another implementation, thank you cards are automatically generated and sent out by mail or through other means such as through email when fund are add to account. An additional record of the deposit and thank you card may also be sent to the beneficiary.

The advertisers may provide advertisement information to an advertisement information portion of the card. For example, in one implementation, advertisers may provide pre-created advertisements to the card publication device for storage in the card generation device along with previously stored advertisements so that advertisements are automatically included with newly generated cards. FIG. 2 illustrates a card that may be generated and provided to consumer for use by a beneficiary in several embodiments.

In another implementation, advertisers may create advertisements electronically and transmit the information regarding the advertising for storage in the advisements are automatically printed on the cards when they are dispersed to the consumer and/or beneficiary. Advertisements are placed on cards which fit the demographic, psychographic, and/or behavioral targets they wish to associate with their advertisements. For example, a jewelry manufacturer may advertisements with cards issued by jewelry departments of stores.

FIG. 3 is an exemplary diagram of a network 300 in which systems and methods consistent with principles of the claimed subject matter may be implemented. Network 300 may include multiple clients 310 connected one or more servers 320 via a network 330. In one embodiment, two clients 310 and three servers 320 have been illustrated as connected to network 330. In other embodiments, there may be more or fewer clients and more or fewer servers. Also, in some embodiments, a client can perform the functions of a server and a server may perform the functions of a client.

Clients 310 may include client devices such as a wireless telephone, a personal computer, a personal digital assistant (PDA), a lap top, or another type of computation or communication device, a thread or process running on one of these devices, and/or an object executable by one of these devices. Servers 320 may also include functions that use these types of devices to gather, process running on one of these devices, and/or an object executable by one of these devices. Servers 320 may also included functions that use theses types of devices to gather, process, search, and/or maintain documents in manner consistent with principles of the claimed subject matter.

In several embodiments, network 330 may include a local area network (LAN), a wide area network (WAN), a telephone network, such as the Public Switched Telephone Network (PSTN), an intranet, the Internet, and/or any combination of networks. Clients 310 and the one or more servers 320 may connect to network 330 via wired, wireless, and/or optical connections.

FIG. 4 is an exemplary diagram of a client or server entity (hereinafter call “client/server entity”), which may correspond to one or more of clients 310 and/or servers 320, according to an implementation consistent with principles of the claimed subject matter. The client/server entity may include a bus 410, a processor 420, a main memory 430, a read only memory (ROM) 440, a storage device 450, an input device 460, an output device 470, a communication interface 480, and a code for funds from multiple user to be tie to one account 490. Bus 410 may include a path that permits communication among the elements of the client/server entity.

Processor 420 may include a processor, microprocessor, or processing logic that may interpret and execute instructions. Main memory 430 may include a random access memory (RAM) and/or any other type of dynamic storage device that may store information and instructions for execution by processor 420. ROM 440 may include a ROM device or another type of static storage device that may store static information and instructions for use by processor 420. Storage device 450 may include a magnetic and/or optical recording medium and one or more corresponding drives.

Input device 460 may include a mechanism that permits an operator to input information to the client/server entity, such as a keyboard, a mouse, a pen, voice recognition and/or biometric mechanisms, etc. Output device 470 may include a mechanism that outputs information to the operator, including a display, a printer, a speaker, etc. Communication interface 480 may include any transceiver-like mechanism that enables the client/server entity to communicate with other devise and/or systems. For example, communication interface 480 may include mechanisms for communicating with another device or system via a network, such as network 330. 490 is the code that ties the funds together from multiple people, which is the uniqueness of this card because it contains all funds on one card vs. 100 from 100 people. Card generating device 495 is any device that generate a financial card using available raw materials.

As will be described in detail below, the client/server entity, consistent with principles of the invention, may perform certain operations. The client/server entity may perform these operations in response to processor 420 executing software instructions contained in a computer-readable medium, such as memory 430. A computer-readable medium may be defined as physical or logical memory device and/or carrier wave.

The software instructions may be read into memory 430 from another computer-readable medium, such as data storage device 450, or from another device via communication interface 480. The software instructions contained in memory 430 may cause processor 420 to perform processes that will accomplish the goals of the claimed subject matter. Alternatively, hardwired circuitry may be used in place of or in combination with software instructions to implement processes consistent with principles of the invention are not limited to any specific combination of hardware circuitry and software.

As will be described in detail below, the client/server entity, consistent with principles of the invention, may correspond to the content providers, advertisers, custom publication creator, and/or customer interface shown in FIG. 5. for example, in one implementation, the card generation device may be implemented on any and/or all of servers 320 and/or on clients 310. For example, a virtual card could be generated on a server 320 and delivered electronically to the customer. In another implementation, the merchant financial card advertising may be implemented on any and/or all of servers 320.

As further shown in FIG. 5, the customer interface connected to the card generation device may provide a number and variety of options to consumer wishing to create a customized card. For example, a user may select the color or print used on the card as well as other information such as section from printed publications, advertisers, and types of advertisements that might interest the customer or beneficiary.

In the exemplary interface shown in FIG. 5, a consumer may select a “Customer Info” tab (e.g., to create, edit and/or input customer information), a “Choose Card” tab (e.g., to search for and/or select a card to associate with the account), and a “Submit” tab (e.g., to activate the account by depositing funds into the account). FIG. 6 shows another exemplary gift card illustration that may be displayed on the kiosk screen to the user when the user is prompted to “Choose Card”. Although FIGS. 2 and 6 shows exemplary cards, many cards may be used instead of or in conjunction with the described and illustrated embodiments, and/or additional functions or features may be incorporated under another optional selection (e.g., the functions of the “Choose Ads” and “Submit” may be included under the “Choose Card” screen).

Additionally, in several implementations, a consumer user may enter keywords in a search box on the kiosk screen to generate a list of content related to the search query such as names in a baby or wedding registry so that a financial card such as a gift card may be generated for the associated beneficiary or beneficiaries. Alternatively, user may perform an advanced search by providing relevant content information. For example, a user may input a publication name, an article name, an author's name, an image name, a publication topic, an article topic, an image topic, etc., or combinations thereof, and then select a “Search” button to generate a list of content related to the advanced search query including the names of prospective beneficiaries and types and contents of the various registries, such as bridal registries and baby registries. In a similar fashion, prospective beneficiaries may create a new listing on the registry so that they may be found using the previously described search feature.

In these embodiments, the consumer user may select the desired card from the generated list (s) of users, and may proceed to select advertisements and features such as texture, color and graphics to include in the customized gift card. The user may pay for the customized card and request a receipt a receipts in a variety of formats (e.g., printed or emailed to the consumer).

The customer interface device of FIG. 5 may be provided in a variety of manners and ways known to those skilled in the art. For example, in one implementation, the customer interface device may be provided via the Internet. In another implementation, the customer interface documents may be provided via a kiosk. For example, kiosk containing the customer interface documents may be provided in stores (e.g., Target, supermarket, retail sores, etc.) in a similar way as picture kiosks are currently provided in such stores.

Also, as shown in FIG. 5, a customer interface device 500 may include a “Customer Info” selector 510 and/or tab 520 (e.g., to edit and/or input customer information), a “Choose Card” selector 530 (e.g., search for and/or select one or more cards), and a “Submit” selector 540 (e.g., to finalize a deposit of funds into an account and/or request that a new account number be created and/or associated with a particular card and/or beneficiary.) FIG. 5 also depicts an exemplary listing of selectable information which can be displayed when the “Customer Info” Selector 510 is displayed to the customer/user. This device may also include a “Customer Information” section where a customer/user ma enter previously entered login information using fields 550 and 560 with login selector 570 to make adjustments to the account information (e.g., to associate new beneficiary with the card account. 580a identify the consumer is the person who open the account and 590a identify all funds go to one account from multiple people (e.g., 580a—When the consumer open the account they are the only one that receive the gift card so this code is create to identify them and 590—is use to unit the funds from multiple people to one card vs. 100 for the same person).

In one embodiment, if a user has previously created a profile, the user may enter a previously assigned username and password and then select a login option displayed on the device's screen. In this same embodiment if the user has not previously created a profile, then the user may register by providing the necessary information in a “Registration Details” section which may request or require a number of pieces of information to identify the user and/or the beneficiary. In several embodiments, this information may also be used to aid merchants as well as third party advertisers to tailor party advertisers to tailor customized advertisement with the consumer and/or beneficiary so that consumer/user can be more likely to be interested in the advertised offerings. (e.g., FIG. 9-12).

In one embodiment, the “Registration Details” may include the name, address, social security number, phone number, event and date of event of the user and/or the beneficiary of the account. It may also request information related to invitees so that invitations to the invitee may be sent via electronic or regular mail so the invitee have the opportunity to participate in making a deposits to the account of the beneficiary.

Also, as previously described, the requested information may also include the methods of payment, the amount for an initial deposit, the information required to create a new username and password and/or any other suitable information. In addition to at least one third party beneficiary, the consumer and the merchant, other third parties may also be involved in the establishment and maintenance of the account. For example, a financial transaction provider may be used by the merchant to maintain the financial account.

In one embodiment, the merchant offers a gift card to a consumer in which the gift card may be used in the future to make purchases of goods or services or any combination of goods and services offered by the merchant. In other embodiments, the gift card may be used at other merchants or it may be used as a prepaid card which is accepted at any merchant that accepts credit cards. Examples of debit or credit card examples that may be used with embodiments of the claimed subject matter include VISA, MasterCard and American Express.

In the present embodiment, the consumer purchases a gift card using the kiosk card generating device and designates a beneficiary for the gift card account. The card is generated with an associated account number with the code identifying them as the consumer who opens the account. The beneficiary's personally identifying information such as such a driver's license number or a student ID number may also be provided for security purposes. The gift card account may also be designated to an anonymous beneficiary known only by the account number or other identifying number associated only with the gift card so that the holder of the gift card is the beneficiary. The amount purchased from the merchant or another third party is then added to the new account. Any other fees to set up the gift card account and gift card may also be charged in this step or in a subsequent step or steps.

In another embodiment, a gift card account is opened by the beneficiary. An account number is assigned to the beneficiary and the beneficiary receives the identifying information in the form of a paper receipt or in the form of a gift card similar in appearance and function to a prepaid debit card or credit card. In some of these embodiments, the beneficiary receives an account number and a PIN code in order to access the account. In other embodiments, the beneficiary would bring the receipt and/of gift card to a cashier where a gift card would be activated. Deposits are made by one or more invitees so that funds are placed into the account for use by the beneficiary.

In these embodiments, the gift card account balance is maintained until the beneficiary elects to use a portion or all the available balance in the gift card account. If the complete balance is used, the gift card associated with the zero balance account may be maintained until the balance is made positive again by additional deposits into the account. In some embodiments, the beneficiary may be restricted on how the funds may be used such as during a specific time period or for specific amounts. The accounts in general may also be restricted by a merchant in any number of manners suitable to the merchant and/or one or more accounts used with the financial card.

In one example, the beneficiary is restricted in how the funds in the account may be used, for instance the time frame in which the funds can be used is restricted to a date in the future or a date range after a date in the future. In another example, a minimum amount of available funds in the account may be required to be accessible by the beneficiary in order for the funds in the account to be made available for use by the beneficiary and applied towards a purchase at the merchant. In another example, one or more follow up purchases may also be required under the terms of the account plan. Other embodiments may have one or more other restrictions, terms or conditions applied to the account in addition to no restrictions at all.

These restrictions may be entered and edited when the account is setup or at a later time. A time limit may also be placed on how long the funds available in an account may be used after the amount becomes available. In some embodiments, the amount may be refunded to the consumer minus a processing fee if the account funds are not used by the beneficiary. In several embodiments, the gift card account may be monitored at anytime online by the consumer and/or the beneficiary as well as any other authorized third party such as the merchant or an administrator or any other entity such as a data aggregating entity.

For example, once authenticated, the beneficiary can retrieve and view his or her account balance and use any available balance in the account as credit towards a purchase. Any purchase information may also be linked to product purchase pages so that the beneficiary could view purchased products and/or services. In other implementations, the consumer of the invitees may also view the purchases so that they can see when and where the funds were spent. In many of the embodiments, more then one consumer can contribute to the financial card account with deposits. Additionally, more then one beneficiary may be associated with single account. In the case of single beneficiary and multiple consumers, multiple deposit amounts are assigned to the account for the single beneficiary.

FIG. 5A is the screen of the invitee, which is used to add the funds to the consumer account. They receive an invitation from the consumer to an event and requested to add funds to the gift card as a present to the consumer. They will receive an account number with the I1AC code at the end of the account number that identifies them as the invitee to the card (which are #570b and #580b). The invitee have three options to add funds to the card, they can go to the merchant locations, call customer service or go on line to add funds to the card. Which with every option they chose the FIG. 5A will be the information that is required to complete this process. When the process has been completed, FIG. 8 is what the invitee will receive from merchant weather it is in person, online or by mail from customer services they will receive two receipts. One for the invitee, of the detail of the transaction of adding funds to the gift card and the other one for the consumer with the invitee's name, amount of funds they added to the card and a special message to the consumer that will be put into FIG. 7 the gift card envelope.

FIG. 7 is an exemplary illustration of a financial card envelope 700 opened to show where a financial card could be placed with embodiments of the claimed subject matter. In this example, the envelope's flap 710 are foldable so that the envelope creates a secure cover over the financial card. Messages including advertising are shown on the inside surface of the flaps 710 so that advertising messages or other personalized messages may be shown to the user when the envelope is opened by the beneficiary. Additionally, an adhesive or slot at position 720 may be included to secure the financial card as well as any other documentation, such as a gift receipt.

FIG. 8 is the image of the receipts of what the invitee will receive from the merchant, online or from customer service by mail for completing the process of applying funds to a consumer gift card. They will receive two receipts. One for the invitee, of the detail deception of the transaction of adding funds to the gift card and the other one for the consumer with the invitee's name, amount of funds they added to the card and a special message to the consumer that will be put into FIG. 7 the gift card envelope.

FIG. 9-13 is other illustrations of how the gift card can be used as a one account gift card for every event in a consumer's life. As well as ways to advertise special unique personable events that are going on at the same time and allowing multiple people to contribute funds to one card vs. 1000.

The foregoing description of the embodiments of the claimed subject matter are provided for illustration and description and are not intended to be exhaustive or to limit the claimed subject matter to the precise form disclosed. Modifications and variations are possible in light of the above teaching or may be acquired from practice of the claimed subject matter.

For example, while series of acts have been described with regard to FIGS. 4-13, the order of the acts may be modified in other implementations consistent with principles of the claimed subject matter. Further, non-dependent acts may be performed in parallel. Additionally, exemplary user interfaces have been described with respect to FIGS. 6 and 7. In other implementations consistent with principles of the claimed subject matter, the user interfaces may include more, fewer, or different pieces of information.

It will be apparent to one of ordinary skill in the art that aspects of the claimed subject matter, as described above, may be implemented in many different forms of software, firmware, and hardware in the implementations illustrated in the figures. The actual software code or specialized control hardware used to implement aspects consistent with principles of the claimed subject matter is not limited of the claimed subject matter. Thus, the operation and behavior of the aspects were described without reference to the specific software code—it being understood the one of ordinary skill in the art would be able to design software and control hardware to implement the aspects based on the description herein.

No element, act or instruction used in the present application should be construed as critical or essential to the claimed subject matter unless it has been explicitly described as such. Also, as used herein, the article “a” is intended to include one or more items. Where only one item is intended, the term “one” or similar language is used. Father, the phrase “based on” is intended to mean “based, at least in part, on” unless explicitly stated otherwise.

### BRIEF DESCRIPTION OF THE DRAWINGS

The accompanying drawings, which are incorporated in and constitute a part of this specification, illustrate several embodiments of the claimed subject matter, and together with the description, serve to explain the principles of the claimed subject matter in the drawings

FIG. 1—Illustrates the process of the One Account Pre-paid Visa/Master/Gift Card. The step by step process outlines the steps needed for account set-up, activation and the depositing of funds on the One Account Pre-Paid Visa/Master/Gift Card. Is the concept consistent with the principles of the claimed subject matter.

FIG. 2—Illustrates a visual of what the front and the back of the card will look like (Temporary Card). This is exemplary diagram of a network in which systems and methods consistent with principles of the invention may be implemented.

FIG. 3—Illustrates how the network will interact with other servers (kiosk), to make sure all data is correct and up-to-date. As well as an exemplary diagram of a client or server of FIG. 2 according to an implementation consistent with principles of the claimed subject matter.

FIG. 4—is the flow chart depicting another embodiment showing the establishment of a financial account for use with a gift, an initial deposit to the gift card account, an additional deposit to the gift card account and a subsequent purchase using the balance of the gift card account by the beneficiary in accordance with the claimed subject matter and

FIG. 5—Illustrates a print screen of what the kiosk input information menu will look like to the purchaser of the One Account Pre-Paid Visa/Master/Gift Card.

FIG. 5a—Illustrates the invitee screen in detail, outlining what is needed to create an invitee account and to attach the funds to the consumer account. The invitee will use the account number, given to them by the consumer along with the code I1AC at the end of the number. This identifies the invitee, as well as all the funds that will go to the consumer account number.

FIG. 6—Illustrates a visual of what the front and the back of the card will look like (Actual Card).

FIG. 7—Illustrates the One Account Pre-Paid Visa/Master/Gift Card envelope that the consumer will receive from the invitee, which shows the dollar amount that was deposited on the One Account Pre-Paid Visa/Master/Gift Card, on their behalf.

FIG. 8—Illustrates the receipts that the invitee will receive once they have deposited into the consumers account and it has completed processing. The invitee will retain a receipt for their records, which will include their personal information, as well as the amount deposited. The other receipt will go into the One Account Pre-Paid Visa/Master/Gift Card envelope with the Invitee's information, the dollar amount and a special pre-printed message.

FIG. 9-13 are exemplary diagrams of exemplary embodiments according to implementations consistent with principles of the claimed subject matter.

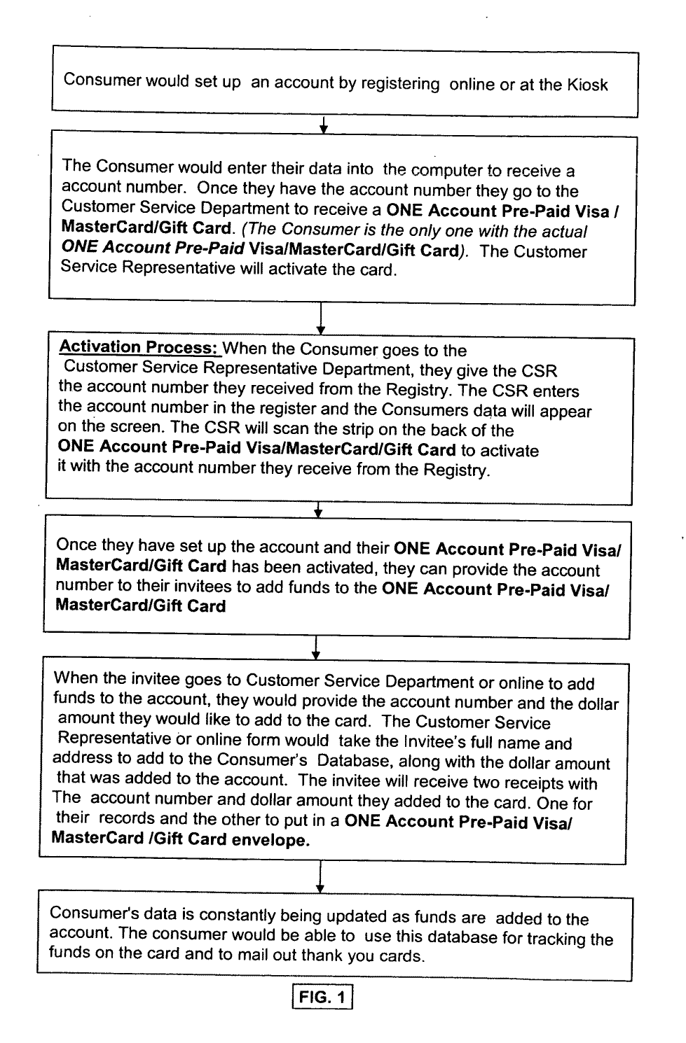

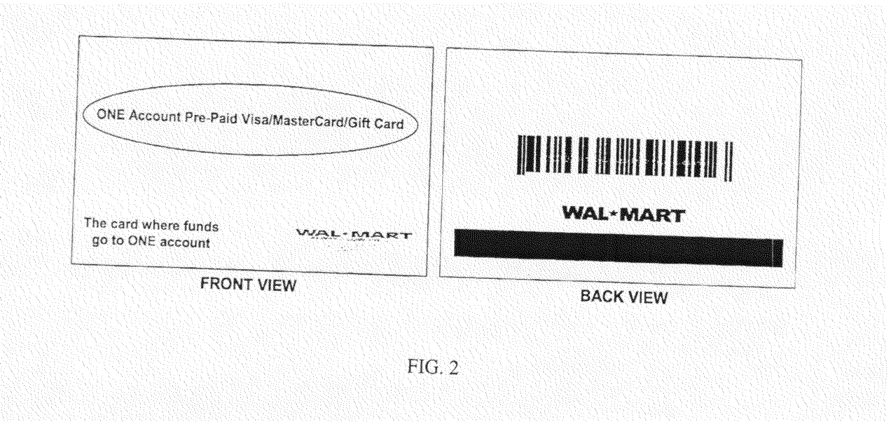

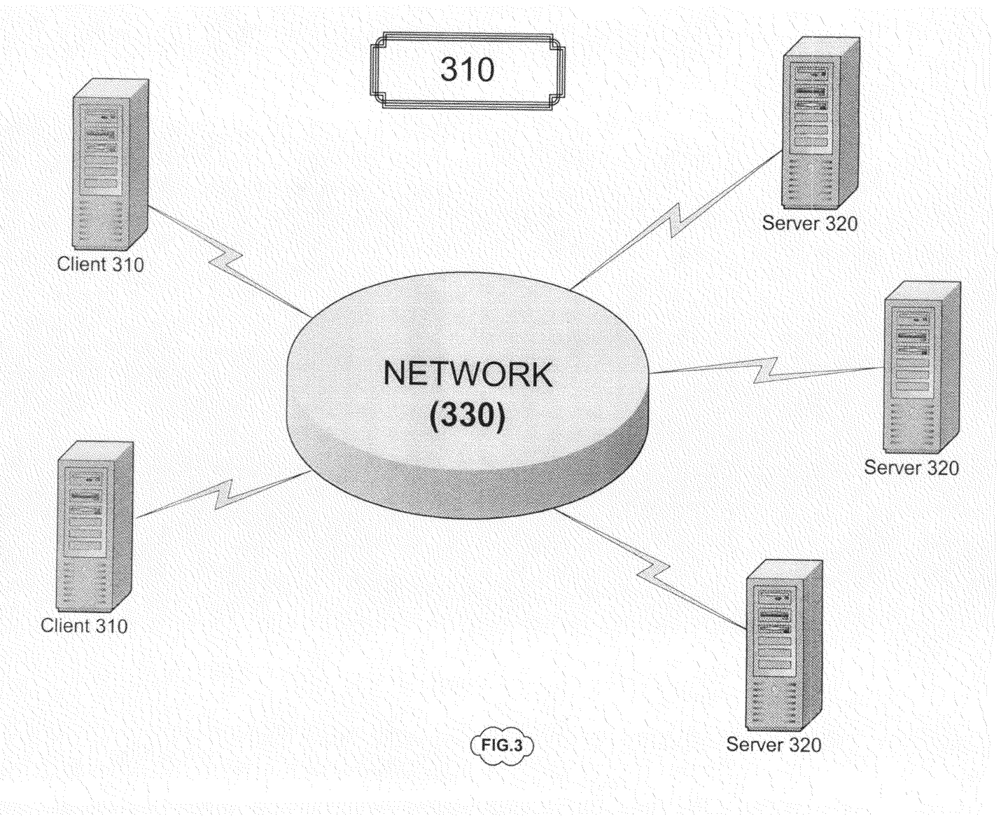

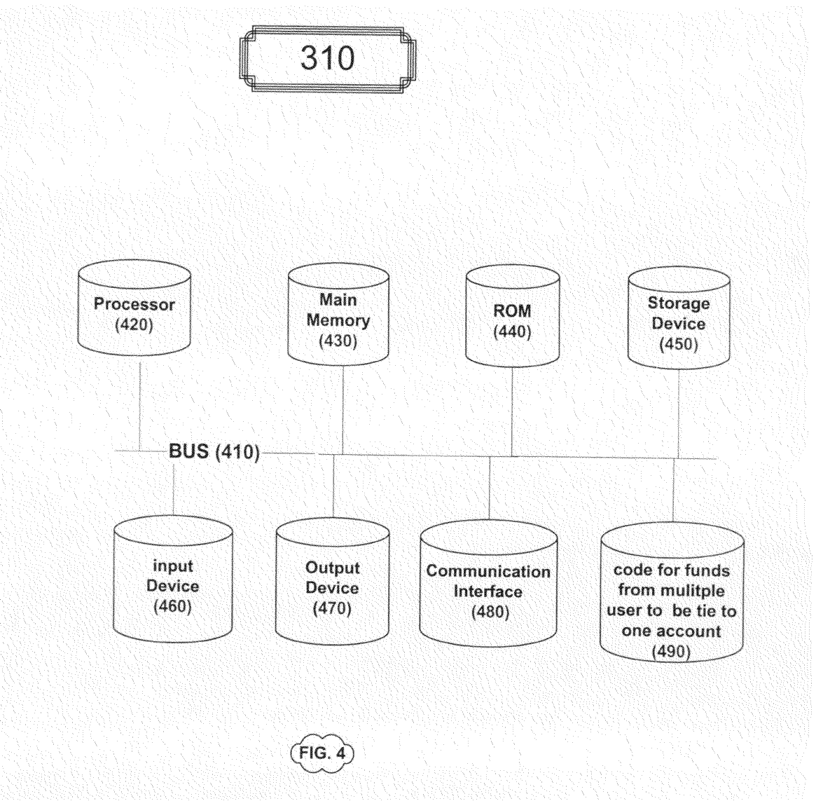

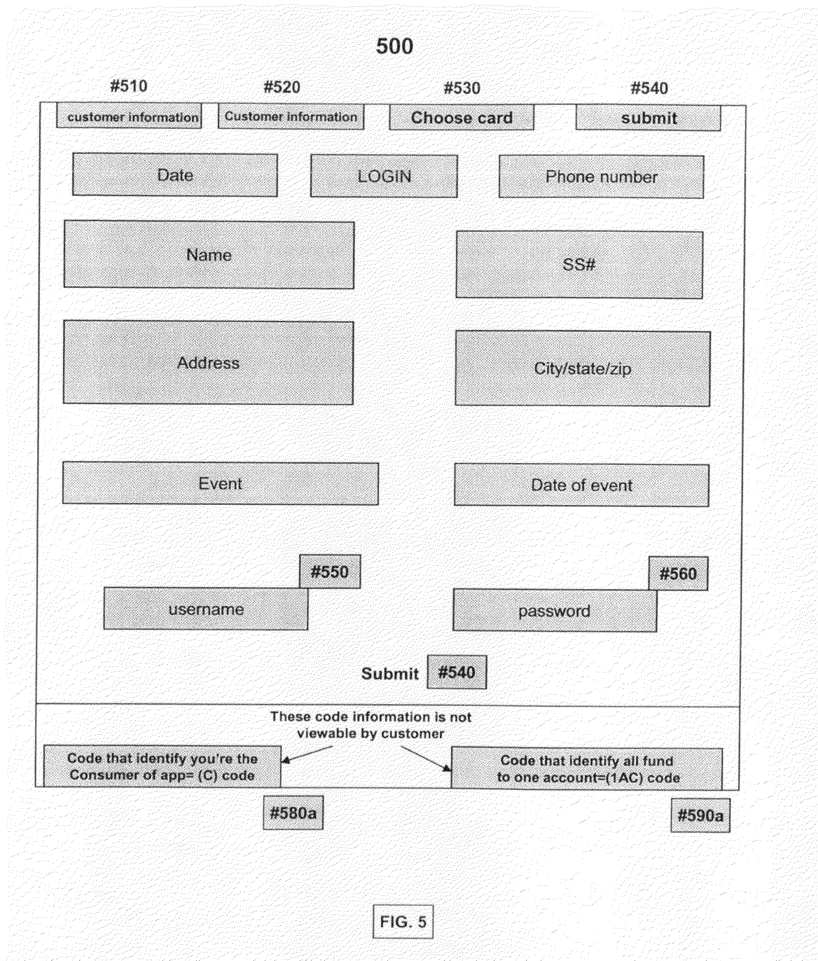

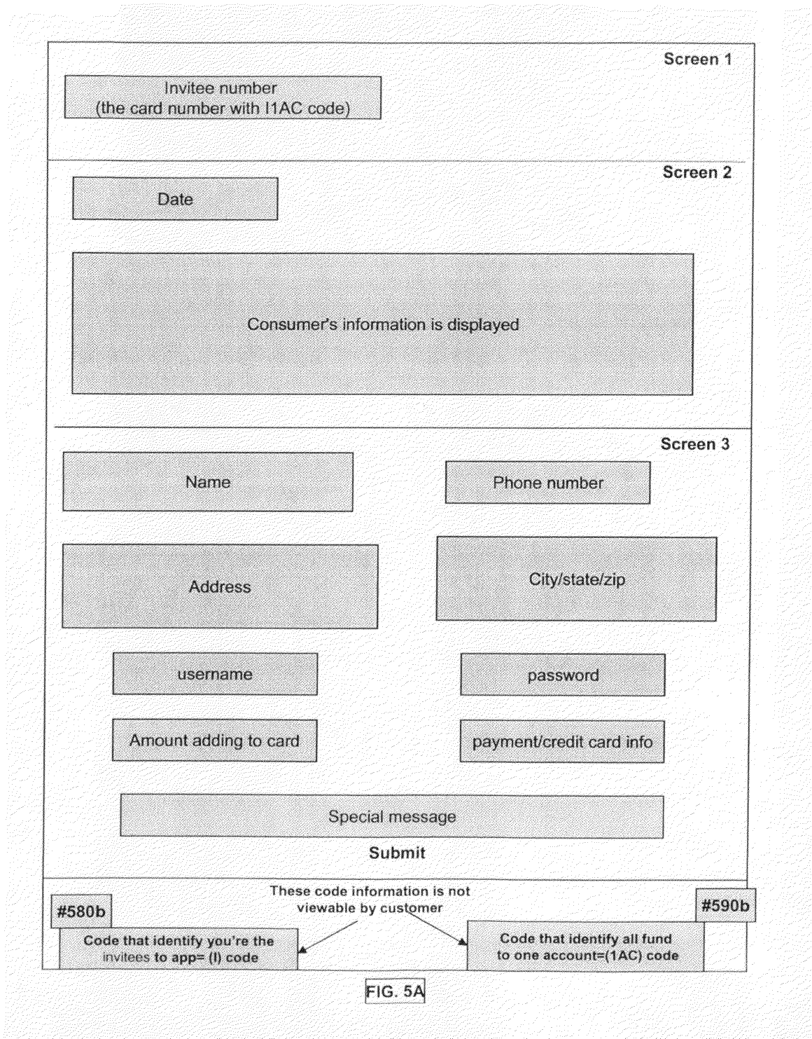

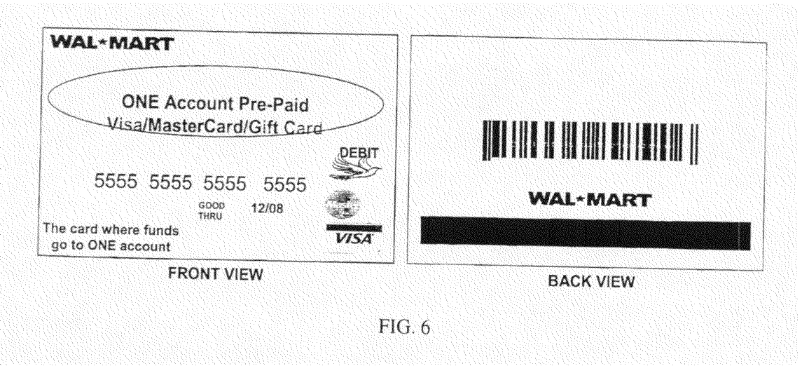

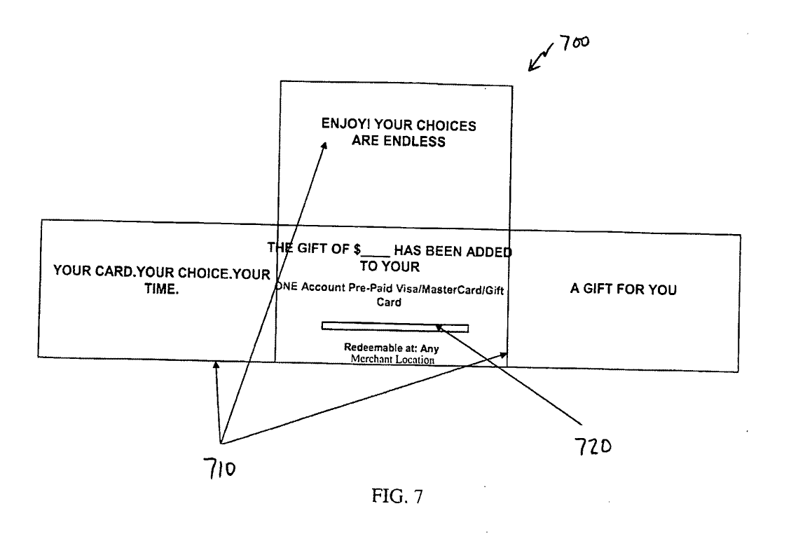

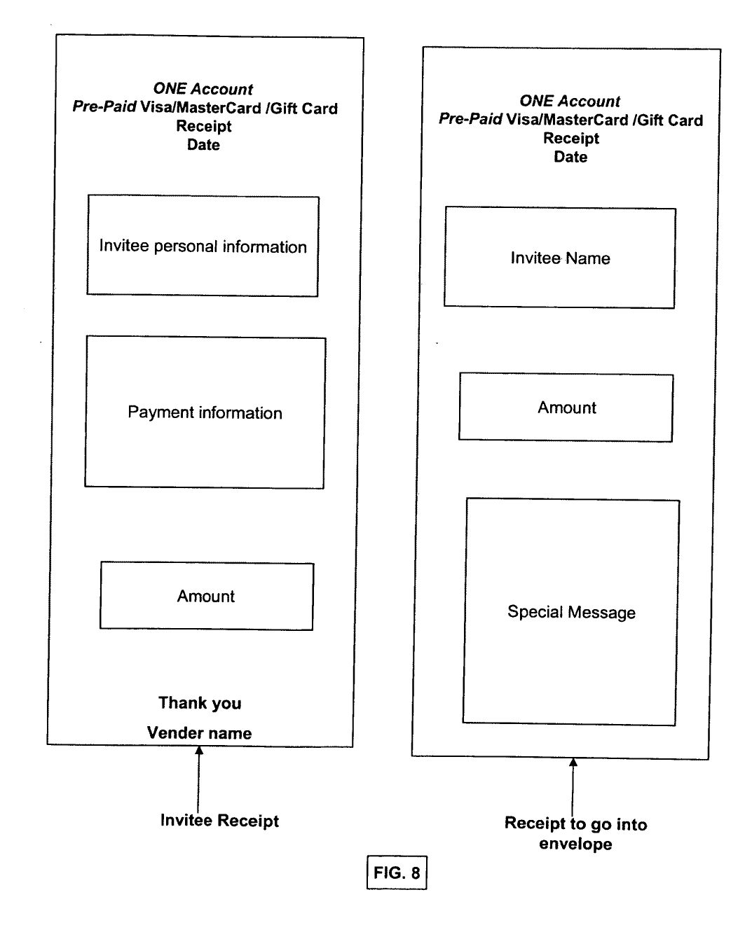

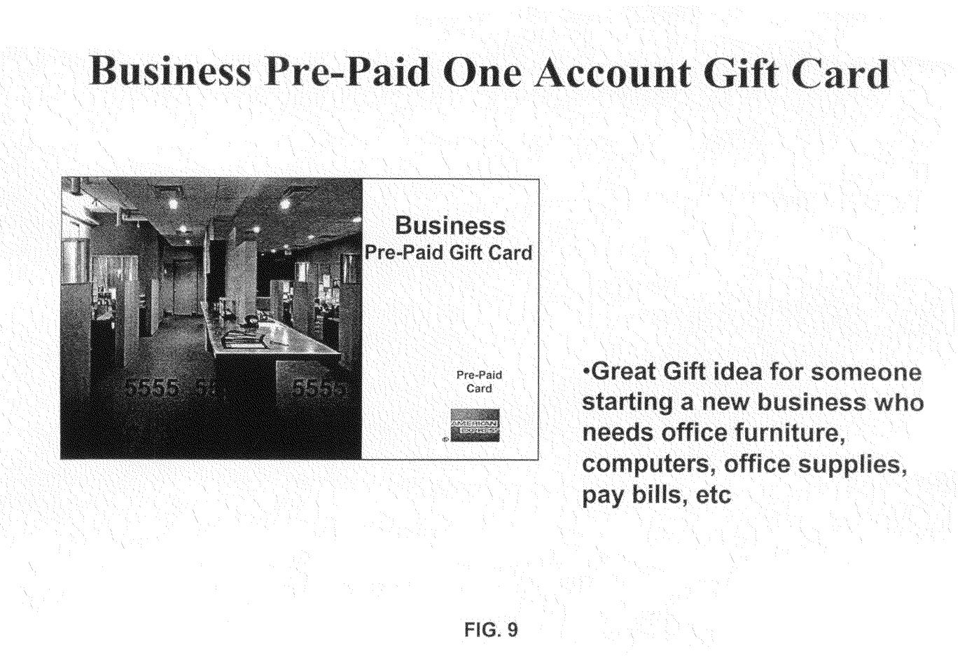

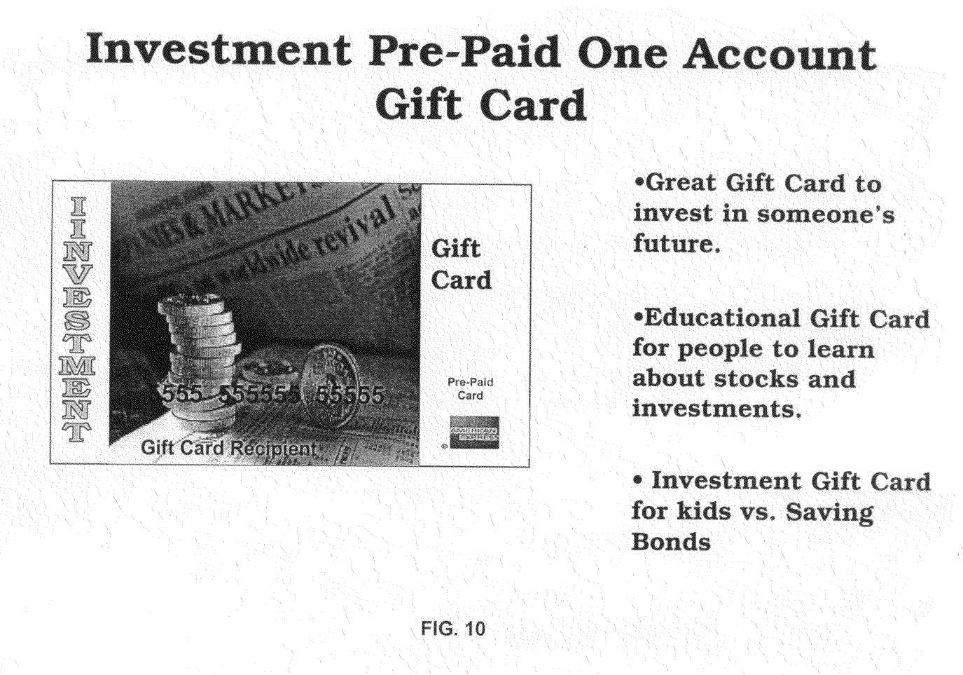

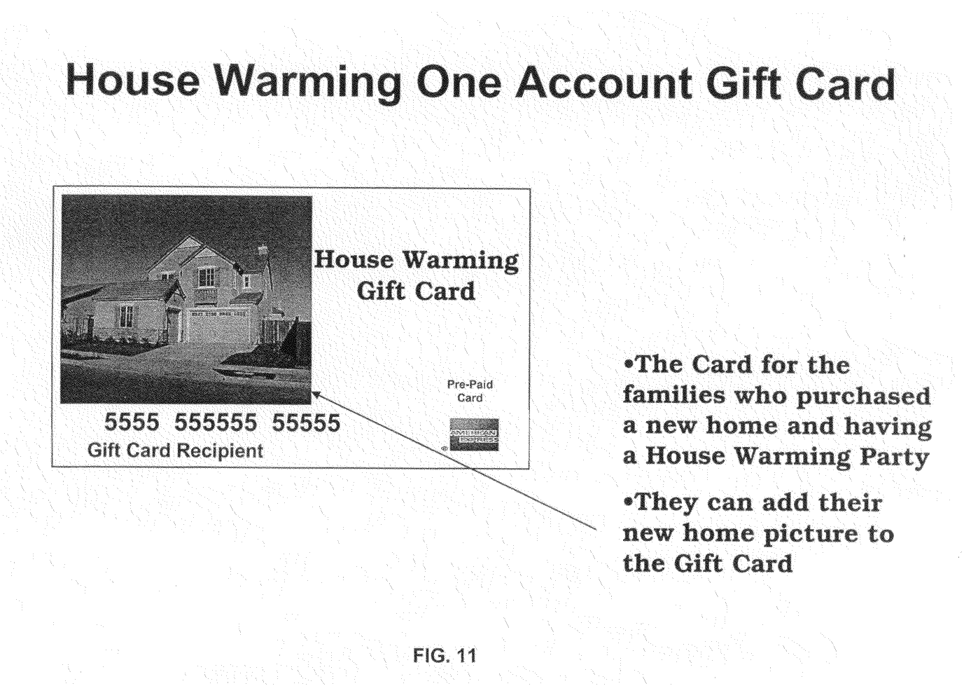

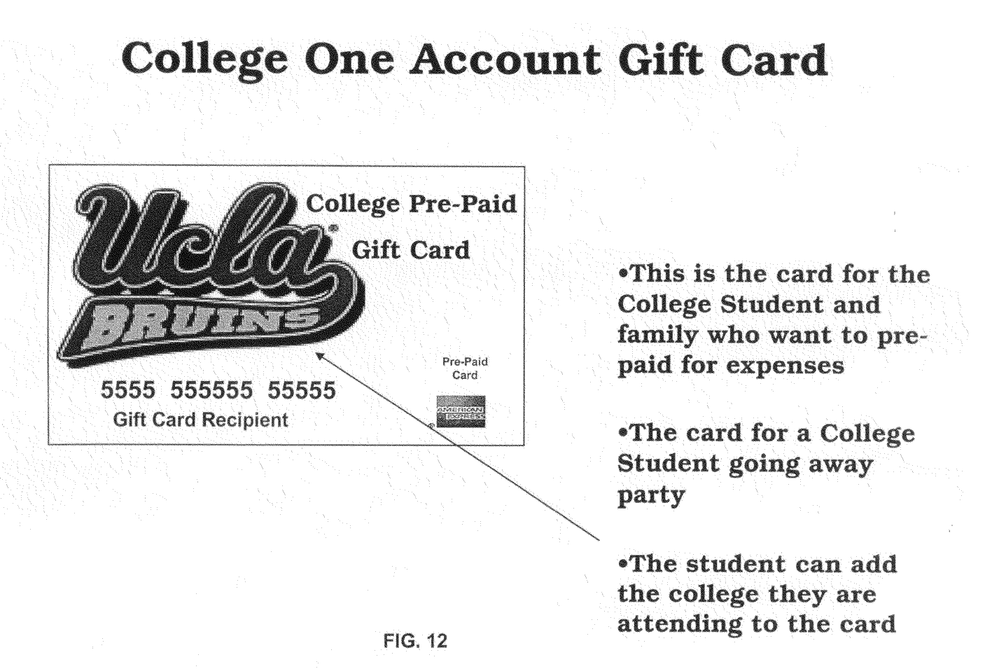

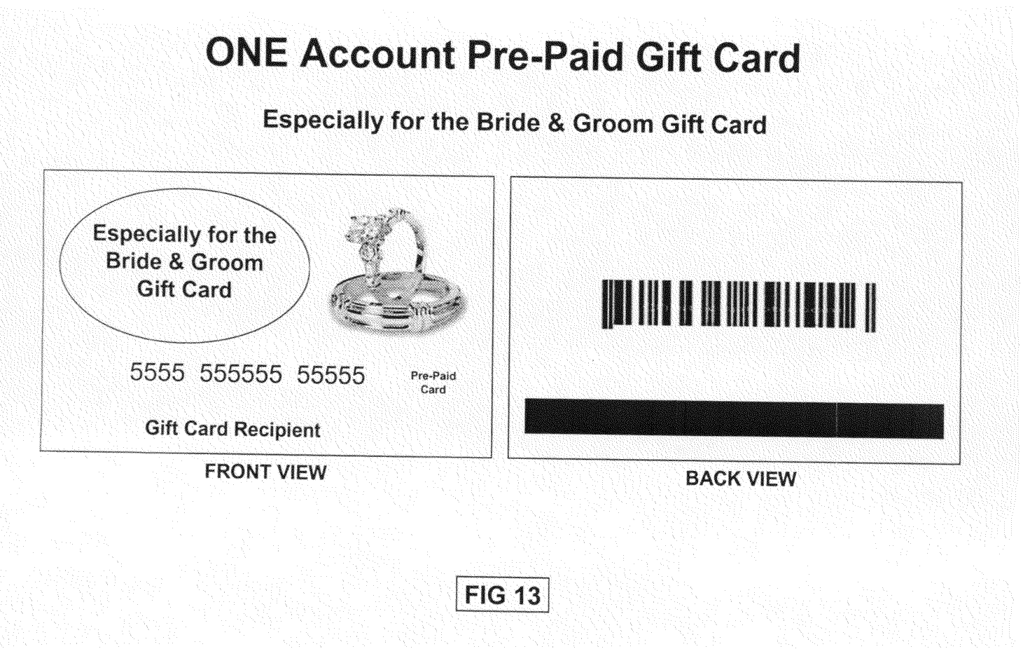

What is claimed is:

1. The method of The ONE Account Pre-Paid Visa/MasterCard/Gift Card is designed to allow an individual consumer the opportunity to purchase a gift of their choice, from a variety of monetary gifts from others.

2. The method claim 1, Is ONE card with ONE account number, with the ability to add funds from multiple people while containing all funds on this ONE card.

3. The method claim 1, you can call it; “The ONE card that does it all.”

4. The method of claim 1, it has ONE account number.

5. The method of claim 1, all funds go to ONE account from multiple people

6. The method of claim 1, it's ONE card vs. 100 cards for the same purchase

7. The method of claim 1, there is no other card like this ONE card

8. A method for providing an account for purchases of goods and/or services by a consumer of claim 1 further comprising the steps of:
creating personalized content based on said user input;
creating a personalized advertisement based on user input; and
delivering said personalized advertisement based on said personalized content to said beneficiary.

9. The method of claim 1, wherein said beneficiary is more than one beneficiary

10. The method of claim 16, where said rebate amount is allocated amount the two or more beneficiaries

11. The method of claim 1, wherein said purchase is more then one purchase.

12. The method of claim 1, wherein said beneficiary can be change at later date.

13. The method of claim 1, wherein said beneficiary receives additional rebates or Incentives to make a purchase.

14. The method of claim 1, wherein said merchant is more then one merchant.

15. The method of claim 1, wherein said account is interest bearing.

16. The method of claim 1, wherein the rebate is provided to the beneficiary customer in The form of one of the following group; a rebate card, a certificate, a voucher, a letter, a Merchant loyalty card, and a smart card.

17. A computer network-based purchase incentive system for one or more merchants, comprising:
a memory, the memory adapted to store a program code;
a processor in communication with the memory, the program code capable of programming the processor to perform a method for providing an account from a merchant for a purchase of a good service by a consumer, the method comprising the step of:
designating a beneficiary to receive an amount associated with an account established for said beneficiary;
establishing said account at a merchant based on a user's input;
and enabling said account to be accessed by the beneficiary with the use of a financial card subject to the terms and conditions of said merchant, wherein said beneficiary uses said account towards purchases of services and/or goods said merchant.

18. A computer program product for use in conjunction with a computer system, the computer Product comprising a computer readable storage medium and a computer program mechanism embedded therein, the computer program mechanism, comprising a program module, the program module including instructions for providing an account from a merchant for a purchase of a good or service by a consumer including:
designating a beneficiary to receive an amount associated with an account established for said beneficiary:
establishing said account at a merchant based on a user's impute; and enabling said account to be accessed by the beneficiary with the use of a financial card subject to the terms and conditions of said merchant, wherein said beneficiary uses said account towards purchases of services and/or goods at said merchant.
